(19) United States
(12) Patent Application Publication
(10) Pub. No.: US 2026/0057397 A1
(43) Pub. Date: Feb. 26, 2026

(54) Carbon Data Management Methods And Systems

(71) Applicant: Siemens Aktiengesellschaft, München (DE)

(72) Inventor: Dai Fei Guo, Beijing (CN)

(73) Assignee: Siemens Aktiengesellschaft, München (DE)

(21) Appl. No.: 19/102,590

(22) PCT Filed: Aug. 10, 2022
(86) PCT No.: PCT/CN2022/111504

§ 371 Date: Feb. 10, 2025

(51) Int. Cl. G06Q 30/018

(52) U.S. Cl. CPC G06Q 30/018

(57) ABSTRACT

Various embodiments of the teachings herein include a carbon data management method. An example includes: acquiring current carbon footprint data of an edge collecting device, wherein the edge collecting device is deployed in a production process; calculating a current deviation statistical index based on historical carbon footprint data of the edge collecting device, wherein the historical carbon footprint data is retrieved from a carbon footprint query database; judging whether the current carbon footprint data is a normal deviation based on the current deviation statistical index; and updating the historical carbon footprint data in the carbon footprint query database based on the current carbon footprint data when the current carbon footprint data is a normal deviation.

### CROSS-REFERENCE TO RELATED APPLICATIONS

This application is a U.S. National Stage Application of International Application No. PCT/CN2022/111504 filed Aug. 10, 2022, which designates the United States of America, the contents of which are hereby incorporated by reference in their entirety.

### TECHNICAL FIELD

The present disclosure relates to computers. Various embodiments of the teachings herein include carbon data management methods, carbon data management apparatus, electronic devices, storage media, and computer program products.

### BACKGROUND

With the development of carbon neutrality, more and more business entities must make public carbon footprint data for the organizations and their products. Since most of the carbon footprint data is provided by the entities themselves, it is not easy to check whether the data is reasonable. Sometimes some corporates provide fake carbon emission data to show their decarbonization progress, which is difficult to monitor. Such behavior interferes with carbon neutrality planning goals. In addition, the carbon footprint is usually calculated manually; this makes it difficult ensure reasonable and accurate results in many cases. Therefore, an accurate and reliable carbon data management scheme is urgently needed.

### SUMMARY

In view of this, embodiments of the present disclosure provide a carbon data management method, a carbon data management apparatus, an electronic device, a storage medium, and a computer program product to at least partially solve the above problems. For example, some embodiments include a carbon data management method comprising: acquiring current carbon footprint data of an edge collecting device, wherein the edge collecting device is deployed in a product processing; calculating a current deviation statistical index based on historical carbon footprint data of the edge collecting device, wherein the historical carbon footprint data is stored in a carbon footprint query database; judging whether the current carbon footprint data is a normal deviation based on the current deviation statistical index; and updating the historical carbon footprint data in the carbon footprint query database based on the current carbon footprint data when the current carbon footprint data is a normal deviation.

In some embodiments, the method further comprises: acquiring product process variation characteristics at the current carbon footprint data collected by the edge collecting device or the input product process variation characteristics when the current carbon footprint data is an abnormal deviation; in the case of not considering the product process variation characteristics, updating the current carbon footprint data into a carbon footprint improvement database as current carbon footprint improvement data when the current carbon footprint data is a normal deviation.

In some embodiments, the method further comprises: in the case of considering the product process variation characteristics, judging that the product process variation characteristics are abnormal when the product process variation characteristics are not in a range of preferred parameters preset according to industry experience, and generating a reminder message for the current carbon footprint data.

In some embodiments, the method further comprises: judging whether historical carbon footprint improvement data in the carbon footprint improvement database is normal based on the current deviation statistical index; updating the historical carbon footprint improvement data into the carbon footprint query database as the historical carbon footprint data when the data is normal.

In some embodiments, the method further comprises: judging that an effect of the product process variation characteristics is normal when the current carbon footprint data is in a carbon footprint data range indicated by the product process variation characteristics, wherein the carbon footprint data range indicated by the product process variation characteristics is input into the carbon footprint improvement database in advance.

In some embodiments, the method further comprises: updating an association between the current carbon footprint data and an identifier of the edge collecting device into a verification blockchain.

In some embodiments, calculating current deviation statistical index based on historical carbon footprint data of the edge collecting device comprises: clustering values of the historical carbon footprint data of the edge collecting device to obtain each current cluster; taking a center value of each current cluster and a distance threshold from the corresponding center value as the current deviation statistical index. Judging whether the current carbon footprint data is a normal deviation based on the current deviation statistical index comprises: if the distance between the value of the current carbon footprint data and the central value of a cluster is not greater than the distance threshold, judging that the current carbon footprint data is a normal deviation when a distance between a value of the current carbon footprint data and the central value of a cluster is not greater than the distance threshold.

In some embodiments, judging whether the current carbon footprint data is a normal deviation based on the current deviation statistical index further/comprises: judging that the current carbon footprint data is an abnormal deviation when a distance between the value of the current carbon footprint data and the central value of each cluster is greater than the distance threshold.

In some embodiments, product process variation characteristics at the current carbon footprint data collected by the edge collecting device or the input product process variation characteristics are acquired; in the case of not considering the product process variation characteristics, the current carbon footprint data is updated into a carbon footprint improvement database when the current carbon footprint data is a normal deviation.

In some embodiments, calculating current deviation statistical index based on historical carbon footprint data H the edge collecting device further comprises: updating a center value of a historical cluster and a distance threshold from the corresponding center value in a carbon footprint benchmark database based on the center value of the current cluster and the distance threshold from the corresponding center value.

As another example, some embodiments include a carbon data management apparatus comprising: an acquisition module, configured to acquire current carbon footprint data of an edge collecting device, wherein the edge collecting device is deployed in a product processing; a calculation module, configured to calculate a current deviation statistical index based on historical carbon footprint data of the edge collecting device, wherein the historical carbon footprint data is stored in a carbon footprint query database; a judgment module, configured to judge whether the current carbon footprint data is a normal deviation based on the current deviation statistical index; an update module, configured to update the historical carbon footprint data in the carbon footprint query database based on the current carbon footprint data when the current carbon footprint data is a normal deviation.

In some embodiments, the acquisition module is further configured to: acquire product process variation characteristics at the current carbon footprint data collected by the edge collecting device or the input product process variation characteristics when the current carbon footprint data is an abnormal deviation. The judgment module is further configured to: in the case of not considering the product process variation characteristics, update the current carbon footprint data into a carbon footprint improvement database as current carbon footprint improvement data when the current carbon footprint data is a normal deviation.

In some embodiments, the judgment module is further configured to: in the case of considering the product process variation characteristics, judge that the product process variation characteristics are abnormal when the product process variation characteristics are not in a range of preferred parameters preset according to industry experience, and generate a reminder message for the current carbon footprint data.

In some embodiments, the judgment module is further configured to: judge whether historical carbon footprint improvement data in the carbon footprint improvement database is normal based on the current deviation statistical index; and update the historical carbon footprint improvement data into the carbon footprint query database as the historical carbon footprint data when the historical carbon footprint improvement data is normal.

In some embodiments, the judgment module is further configured to: judge that an effect of the product process variation characteristics is normal when the current carbon footprint data is in a carbon footprint data range indicated by the product process variation characteristics, wherein the carbon footprint data range indicated by the product process variation characteristics is input into the carbon footprint improvement database in advance.

In some embodiments, the update module is further configured to: update an association between the current carbon footprint data and an identifier of the edge collecting device into a blockchain.

In some embodiments, the calculation module is configured to: cluster values of the historical carbon footprint data of the edge collecting device to obtain each current cluster; and take a center value of each current cluster and a distance threshold from the corresponding center value as the current deviation statistical index. The judgment module is configured to: judge that the current carbon footprint data is a normal deviation when a distance between a value of the current carbon footprint data and the central value of a cluster is not greater than the distance threshold.

In some embodiments, the judgment module is further configured to: judge that the current carbon footprint data is an abnormal deviation when a distance between the value of the current carbon footprint data and the central value of each cluster is greater than the distance threshold. The acquisition module is further configured to: acquire product process variation characteristics at the current carbon footprint data collected by the edge collecting device or the input product process variation characteristics. The judgment module is further configured to: in the case of not considering the product process variation characteristics, update the current carbon footprint data into a carbon footprint improvement database as current carbon footprint improvement data when the current carbon footprint data is a normal deviation.

In some embodiments, the calculation module is configured to: update a center value of a historical cluster and a distance threshold from the corresponding center value in a carbon footprint benchmark database based on the center value of the current cluster and the distance threshold from the corresponding center value.

As another example, some embodiments include an electronic device comprising: a processor, a memory, a communication interface and a communication bus, wherein the processor, the memory and the communication interface communicate with each other through the communication bus; the memory is configured to store at least one executable instruction, and the executable instruction enables the processor to perform one or more of the methods described herein.

In some embodiments, a storage medium stores computer executable instructions thereon, wherein the computer executable instructions, when executed, implement one or more of the methods described herein.

In some embodiments, a computer program product comprises a computer readable storage medium on which a program code is stored, wherein the program code, when loaded into a memory of a computer, cause the computer to perform execute one or more of the methods described herein.

### BRIEF DESCRIPTION OF THE DRAWINGS

In order to explain the embodiments of the present disclosure or the technical schemes in the prior art more clearly, the drawings are briefly introduced here. The drawings in the following description are only some of the embodiments of the present disclosure. For those skilled in the art, other drawings can be obtained according to these drawings.

FIG. 1 is a schematic architecture diagram of an example carbon data management system incorporating teachings of the present disclosure;

FIG. 2 is a flowchart of an example carbon data management method incorporating teaching of the present disclosure;

FIG. 3 is a flowchart of an example carbon footprint data analysis process incorporating teachings of the present disclosure;

FIG. 4 is a flowchart of an example carbon footprint data analysis process incorporating teachings of the present disclosure;

FIG. 5 is a structural schematic diagram of an example carbon data management apparatus incorporating teachings of the present disclosure; and

FIG. 6 is a structural schematic diagram of an example electronic device incorporating teachings of the present disclosure.

### DETAILED DESCRIPTION

Judging whether the current carbon footprint data is a normal deviation based on the current deviation statistical index of historical carbon footprint data improves the statistical analysis accuracy of carbon footprint data. When the carbon footprint query database is updated, the historical carbon footprint data is also updated accordingly, which further improves the accuracy of carbon footprint data in the carbon footprint query database and improves the management efficiency of carbon footprint data. In addition, the carbon footprint data is acquired by the edge acquisition equipment and then reported, thus avoiding the risk of tampering with the carbon footprint data.

To better understand the technical schemes of the present disclosure, they are described clearly and in detail with reference to the attached drawings. The described embodiments are only representative of the embodiments of the present disclosure, rather than an exhaustive list. All other embodiments obtained by those skilled in the art belong to the scope of protection of the present disclosure. The concrete implementation of the embodiments of the present disclosure will be further explained with reference to the drawings.

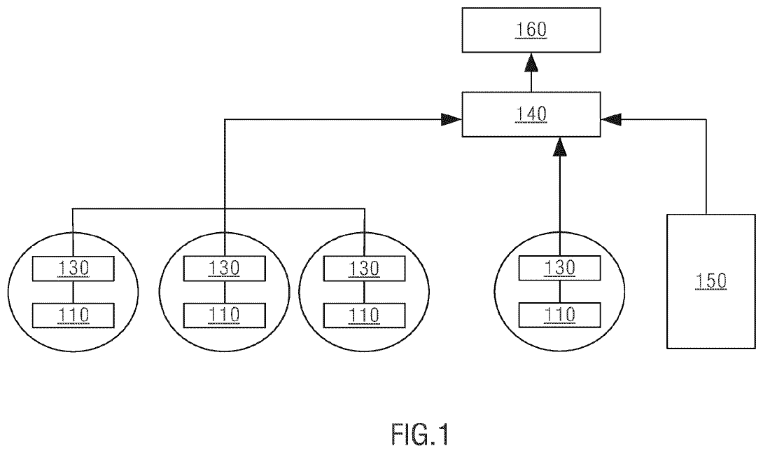

FIG. 1 schematically shows a schematic architecture diagram of an example carbon data management system incorporating teachings of the present disclosure. As shown in FIG. 1, the architecture of the carbon data management system can comprise a carbon emission source and/or a carbon emission reduction source (for example, the carbon emission source herein labeled as 110) deployed at the carbon emission entity side, an edge collecting device 130 provided at the carbon emission source and the carbon emission reduction source, and a carbon footprint management device 140 deployed at the network side.

The carbon emission entity can be any organization, group, or individual that produces carbon dioxide emission behavior. In some embodiments, the carbon emission entity may include business organizations, communities, or other independent accounting organizations that have greenhouse gas (such as carbon dioxide) emission behaviors and should be accounted for.

The carbon emission source 110 is the source of carbon emission behavior produced by the carbon emission entity. In some embodiments, the carbon emission source may include an energy-consuming device of the carbon emission entity, and the energy-consuming device may emit carbon dioxide in the process of using one or more energy sources such as water, electricity, coal, oil, etc. The energy-consuming device referred to in the embodiment of the present disclosure may be a single device or a device cluster formed by a plurality of devices.

In some embodiments, the carbon emission source may be, for example, an electric-consuming device, a water-consuming device, a coal-consuming device, an energy-consuming device that uses a plurality of kinds of energy sources in corporations, etc. It should be noted that the carbon emission entity does not necessarily produce carbon dioxide emissions in the form of energy consumption by the energy-consuming device. The energy-consuming device is only an optional form of carbon emission source. Any device, people, and other sources that produce carbon emission behaviors in the production, life and other activities of the carbon emission entity can be regarded as the carbon emission sources referred to in the embodiment of the present disclosure. The forms of carbon emission sources of different carbon emission entities may be different, and the specific forms of carbon emission sources may depend on the specific production, life and other activities of carbon emission entities, which is not limited in the present disclosure.

The carbon emission reduction source is the source of carbon emission reduction behavior produced by the carbon emission entity. In some embodiments, the carbon emission entity may achieve carbon emission reduction behavior by obtaining clean energy. For example, the carbon emission entity can achieve carbon emission reduction behavior by photovoltaic power generation and wind power generation. In one example, the carbon emission reduction source can be a clean energy power generation device such as a photovoltaic power generation device and a wind power generation device used by carbon emission entities such as corporates and communities. In some embodiments, the carbon emission entity may also achieve carbon emission reduction behavior by specific energy-saving and emission-reduction activities. For example, the carbon emission entity can achieve carbon emission reduction behavior by turning off the energy-consuming device. Using the clean energy power generation device and turning off the energy-consuming device are only optional forms for carbon emission entities to achieve carbon emission reduction behavior, and the embodiment of the present disclosure does not limit the specific forms for carbon emission entities to achieve carbon emission reduction behavior.

If the carbon emission source data and the carbon emission reduction source data are manually measured and uploaded by the carbon emission entity, the measurement of the carbon emission source data and the carbon emission reduction source data may be inaccurate or even tampered with, which will lead to the inaccuracy of the carbon-related data (such as carbon emission and carbon emission reduction, etc.) of the carbon emission entity calculated later. Based on this, teachings of the present disclosure can provide the edge collecting device 130 at each carbon emission source and each carbon emission reduction source of the carbon emission entity. For example, the method or system can inventory the carbon emission source and the carbon emission reduction source of carbon emission entities such as corporations and communities, and add an edge collecting device to the carbon emission source and carbon emission reduction source in the inventory results. For the carbon emission source, the edge collecting device can collect and measure the carbon emission source data and upload the data to the carbon footprint management device 140. For the carbon emission reduction source, the edge collecting device can collect and measure the carbon emission reduction source data and upload the data to the carbon footprint management device 140.

In some embodiments, the edge collecting device can transmit the collected and measured carbon emission source data and carbon emission reduction source data to the carbon footprint management device 140 in real time or at regular time. The carbon footprint management device 140 may be a server platform deployed at the network end (e.g., the cloud) of the embodiment of the present disclosure, and is configured to provide carbon data management services for carbon emission entities. As an alternative implementation, the carbon footprint verification device may comprise one or more servers.

In some embodiments, the carbon footprint verification device can provide carbon accounts for carbon emission entities. For example, carbon emission entities can register carbon accounts in the carbon footprint verification device. Therefore, the carbon footprint verification device can provide carbon data management services to different carbon emission entities based on carbon accounts.

The carbon footprint verification device 160 is a verification platform that provides carbon-related services and is configured to provide verification services for carbon emission indexes of carbon emission entities. The carbon emission indexes of carbon emission entities have high credibility after being verified. The carbon emission index verification platform is a service platform configured to verify the current status of carbon emission indexes of carbon emission entities, which is generally provided by government agencies.

The carbon footprint verification device 160 may be configured with a blockchain to prevent the carbon data of the carbon data management device 140 from being tampered with.

In some embodiments, the carbon data management system may further comprise a management terminal 150 communicatively connected with the carbon data management device. The management terminal 150 is the terminal device (e.g., computers, mobile phones and other electronic devices) used by carbon emission entities. In some embodiments, carbon emission entities can use various management services provided by the carbon footprint verification device through the management terminal 150. In some embodiments, the various management services include: managing the edge collecting device, editing the information of the carbon emission entity, browsing the carbon data management data of different time periods, browsing the total energy consumption and the energy consumption distribution of the carbon emission entity calculated by the carbon footprint verification device, browsing the total carbon emissions of the carbon emission entity calculated by the carbon footprint verification device, the carbon emission distribution of various types of energy sources, etc.

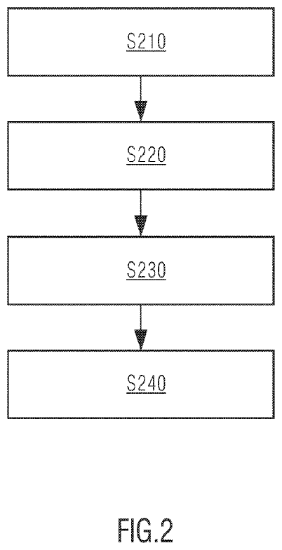

The carbon data management method of FIG. 2 can be applied to the carbon footprint management device 140 of FIG. 1. The carbon data management method comprises the following steps.

S210: current carbon footprint data of an edge collecting device is acquired, wherein the edge collecting device is deployed in a product processing. For example, the edge collecting device of this embodiment may be the edge collecting device 130 in FIG. 1. The product processing comprises a product assembly and a product production. In the production process of product components, product components are formed into components for product assembly through various processes (production links) of the production line. In product assembly, the components which are produced already are assembled into products and then delivered from the factory. The product processing can be used as an example of the carbon emission entity or the carbon emission reduction entity in FIG. 1.

In one example, taking the carbon emission source as an energy-consuming device as an example, the edge collecting device can collect the energy consumption of the energy-consuming device. For example, the edge collecting device can be a smart electricity meter for collecting and measuring electricity consumption, a smart water meter for collecting and measuring water consumption, a smart gas meter for collecting and measuring gas consumption, etc. Taking the carbon emission reduction source as a clean energy power generation device as an example, the edge collecting device can collect and measure the power generation of the clean energy power generation device. For example, the edge collecting device can be a photovoltaic meter that collects the power generation of a photovoltaic power generation device.

There are many types of edge collecting devices, and correspondingly, the types of carbon emission source data and carbon emission reduction source data collected by different types of edge collecting devices may be different. For example, the type of carbon emission source data collected by the smart water meter is water consumption, and the type of carbon emission source data collected by the smart electricity meter is electricity consumption. The specific type of the edge collecting device may depend on the specific form of carbon emission behavior generated by the carbon emission source and the specific form of carbon emission reduction behavior generated by the carbon emission reduction source, which is not limited in the embodiment of the present disclosure. Furthermore, a carbon emission source may need to be provided with various types of edge collecting devices, and a carbon emission reduction source may also need to be provided with various types of edge collecting devices. For example, an energy-consuming device may use various types of energy sources such as water and electricity at the same time. Therefore, the energy-consuming device needs to be provided with various types of edge collecting devices such as smart water meters and smart electricity meters.

As the carbon emission source and the carbon emission reduction source may coincide with each other, the source data collected by the edge collecting device may be either carbon emission source data or carbon emission reduction source data. For example, if the energy-consuming device becomes a carbon emission source during use, the energy consumption collected by the edge collecting device during use of the energy-consuming device can be carbon emission source data. In addition, if the energy-consuming device becomes the carbon emission reduction source when it is turned off, the saved energy consumption acquired and measured by the edge collecting device when the energy-consuming device is turned off can become the carbon emission reduction source data.

In addition, the carbon emission source data and/or the carbon emission reduction source data can be converted into carbon footprint data at the edge collecting device or the carbon data management device. The edge collecting device 130 can also be configured with a blockchain to prevent the tamper to the carbon emission source data and/or carbon emission reduction source data, and the carbon footprint data.

S220: a current deviation statistical index is calculated based on historical carbon footprint data of the edge collecting device, wherein the historical carbon footprint data is stored in a carbon footprint query database. The setting of the current deviation statistical index depends on the statistical analysis methods, including but not limited to standard deviation analysis, variance analysis, cluster analysis, regression analysis, etc. The deviation statistical index includes but is not limited to standard deviation, variance, cluster center, regression function, etc. The historical carbon footprint data and the current carbon footprint data are collected at different time points, and the carbon footprint analysis according to the embodiment of the present disclosure is performed for each edge collecting device.

S230: it is judged whether the current carbon footprint data is a normal deviation based on the current deviation statistical index.

For example, the threshold range corresponding to the current deviation statistical index is determined, and it is judged whether the current carbon footprint data value is in the threshold range. If so, the current carbon footprint data value is normal.

S240: if the current carbon footprint data is a normal deviation, the historical carbon footprint data is updated in the carbon footprint query database based on the current carbon footprint data. For example, the current carbon footprint data is added to the carbon footprint query database, and the historical carbon footprint data is updated. The carbon footprint query database is used to store the carbon footprint data that meets the deviation statistical index. For example, an association between the carbon footprint data and an identifier of the edge collecting device can be stored for subsequent query of the carbon footprint data.

In some embodiments, each product component of a product can be obtained, then the identifier of each edge collecting device corresponding to the processing of each product component can be determined, and then the carbon footprint data corresponding to the identifier of each edge collecting device can be accumulated to obtain the carbon footprint data of the queried product.

Judging whether the current carbon footprint data is a normal deviation based on the current deviation statistical index of historical carbon footprint data improves the statistical analysis accuracy of carbon footprint data; and when the current carbon footprint data is updated, the historical carbon footprint data is also updated accordingly, which further improves the accuracy of carbon footprint data in the carbon footprint query database and improves the management efficiency of carbon footprint data. In addition, the carbon footprint data is acquired by the edge acquisition equipment and then reported, thus avoiding the risk of tampering with the carbon footprint data.

In some embodiments, based on the device information edited by the management terminal on the device editing page, the carbon footprint verification device can determine whether the source data belongs to the carbon emission source data or the carbon emission reduction source data after obtaining the source data collected by the edge collecting device, and determine the carbon emission entity to which the source data belongs (such as the carbon account to which the source data belongs). The carbon footprint verification device can then store carbon emission source data and carbon emission reduction source data of different carbon emission entities at different times in the database based on carbon accounts. Thus, the embodiment of the present disclosure can provide data support for the carbon footprint verification device to realize the adjustment of management of carbon data and the calculation of carbon-related data by arranging the edge collecting device on the side of the carbon emission entity and storing the received source data at different times by the carbon footprint verification device.

In some embodiments, the carbon footprint verification device can communicate with the carbon data management device, so that the carbon emission entity can use the services provided by the carbon footprint verification device through the carbon footprint verification device. For example, the carbon footprint verification device can provide a service interface of the carbon footprint verification device, so that the carbon emission entity can use the service provided by the carbon footprint verification device 160 through the management terminal using the service interface.

As the edge collecting device provided at the carbon emission source and the carbon emission reduction source need to communicate with the carbon footprint verification device, when adding or modifying the edge collecting device of the carbon emission source and the carbon emission reduction source, the carbon emission entity can edit the edge collecting device through the management terminal and inform the carbon footprint verification device. As an alternative implementation, the carbon emission entity can display the device editing page of the carbon account through the management terminal to edit the edge collecting device communicated with the carbon footprint verification device. Taking the carbon emission reduction source as a photovoltaic power generation device and the edge collecting device as a photovoltaic meter as an example, the carbon emission entity can edit and configure the information of the photovoltaic meter such as the device name, the factory area, the device number, the superior device, the device type (the device type can determine the specific type of carbon emission source data and carbon emission reduction source data), the measurement direction, the device brand, the device model, the device attribute, and the affiliated household number (such as the affiliated carbon account).

In some embodiments, the carbon data management method further comprises: acquiring product process variation characteristics at the current carbon footprint data acquired by the edge collecting device or the input product process variation characteristics when the current carbon footprint data is an abnormal deviation,; and in the case of not considering the product process variation characteristics, updating the current carbon footprint data into a carbon footprint improvement database as the current carbon footprint improvement data when the current carbon footprint data is a normal deviation. When the carbon footprint data is an abnormal deviation, but the effect of the product process variation characteristics is normal, the carbon footprint data may also be reasonable, thus avoiding that the carbon footprint data is mistakenly discarded as abnormal data when it is judged to be abnormal.

In some embodiments, the carbon data management method further comprises: in the case of considering the product process variation characteristics, judging that the product process variation characteristics are abnormal when the product process variation characteristics are not in the range of preferred parameters preset according to industry experience, and correspondingly, generating a reminder message for the current carbon footprint data. When the carbon footprint data is an abnormal deviation and the product process variation characteristics are abnormal, it means that the carbon footprint data is unreasonable, and a reminder message is generated to inform relevant personnel to improve the product processing at the corresponding edge collecting nodes.

In some embodiments, the carbon data management method further comprises: judging whether the historical carbon footprint improvement data in the carbon footprint improvement database is normal based on the current deviation statistical index; if the data is normal, updating the historical carbon footprint improvement data into the carbon footprint query database as the historical carbon footprint data. This example prevents the carbon footprint data from being misjudged when the historical deviation statistical index is inaccurate.

In some embodiments, the carbon data management method further comprises: judging that the influence of the product process variation characteristics is normal when the current carbon footprint data is in the carbon footprint data range indicated by the product process variation characteristics, wherein the carbon footprint data range indicated by the product process variation characteristics is input into the carbon footprint improvement database in advance.

In some embodiments, the current peripheral carbon footprint data of a group of edge collecting devices around the edge collecting devices are acquired. If both the current carbon footprint data and the current peripheral carbon footprint data are abnormal, it is judged that the effect of the product process variation characteristics is normal. A group of edge collecting devices and the edge collecting device have the same product improvement process. When both the current carbon footprint data and the current peripheral carbon footprint data are abnormal, it means that the abnormality of the current carbon footprint data is related to the variation of processing conditions, which improves the accuracy of abnormal judgment of carbon footprint data.

In some embodiments, the carbon data management method further comprises updating the association between the current carbon footprint data and the identifier of the edge collecting device into a blockchain. The blockchain can be saved into the carbon footprint verification device 160 as shown in FIG. 1. The blockchain avoids the tamper to carbon footprint data and ensures data security, thus ensuring carbon supervision of emission-related processing activities.

In some embodiments, calculating current deviation statistical index based on historical carbon footprint data of the edge collecting device comprises: clustering the values of the historical carbon footprint data of the edge collecting device to obtain each current cluster; taking the center value of the current cluster and the distance threshold from the corresponding center value as the current deviation statistical index. Judging whether the current carbon footprint data is a normal deviation based on the current deviation statistical index comprises: if the distance between the value of the current carbon footprint data and the central value of a cluster is not greater than the distance threshold, judging that the current carbon footprint data is a normal deviation. As a statistical analysis method, the clustering can reliably measure the dispersion degree of carbon footprint data and determine the carbon footprint data belonging to the cluster as normal data with low dispersion degree (that is, meeting the current deviation statistical index), thus ensuring the accuracy of statistical analysis.

In some embodiments, judging whether the current carbon footprint data is a normal deviation based on the current deviation statistical index further comprises: if the distance between the value of the current carbon footprint data and the central value of each cluster is greater than the distance threshold, judging that the current carbon footprint data is an abnormal deviation; acquiring product process variation characteristics at the current carbon footprint data acquired by the edge collecting device or the input product process variation characteristics; in the case of not considering the product process variation characteristics, if the current carbon footprint data is a normal deviation, updating the current carbon footprint data into a carbon footprint improvement database as current carbon footprint improvement data. In this example, the carbon footprint data that does not belong to the cluster is judged as abnormal data with high dispersion (that is, without meeting the current deviation statistical index), thus ensuring the accuracy of statistical analysis.

In some embodiments, calculating a current deviation statistical index based on historical carbon footprint data of the edge collecting device comprises: updating the center value of a historical cluster and the distance threshold from the corresponding center value in a carbon footprint benchmark database based on the center value of the current cluster and the distance threshold from the corresponding center value. By maintaining the carbon footprint benchmark database, the deviation statistic index is updated in time, and the analysis accuracy of subsequent carbon footprint data is ensured.

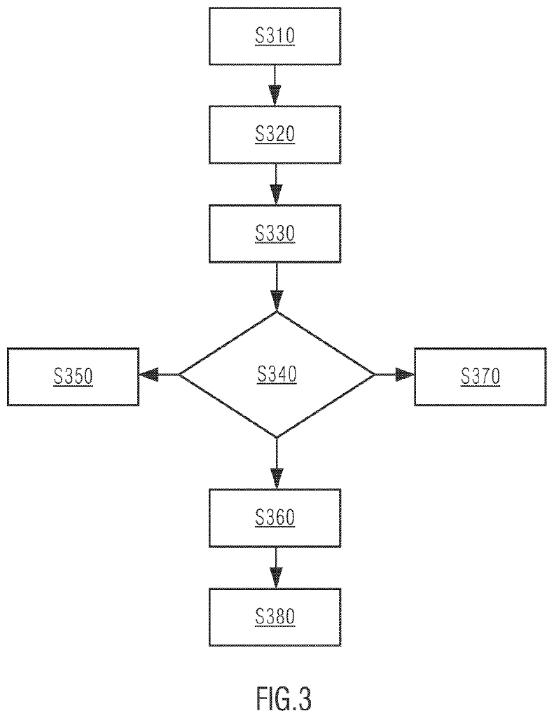

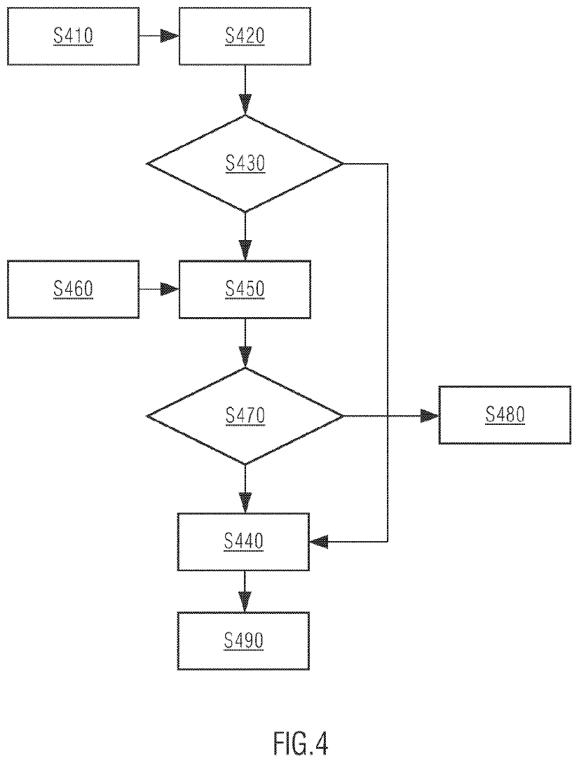

Different examples of the carbon footprint data analysis process of the embodiment of FIG. 2 will be described in detail with reference to FIG. 3 and FIG. 4 hereinafter. The carbon footprint data analysis process in FIG. 3 comprises the following:

S310: the current acquisition data is acquired, and continue to execute S320. For example, the current acquisition data can be carbon emission source data and/or carbon emission reduction source data, and the current acquisition data reflects the carbon emission and/or carbon emission reduction collected by the edge collecting device.

S320: the current acquisition data is preprocessed to obtain the current carbon footprint data and continue to execute S330. For example, when the collecting units of the current acquisition data are different, or the models of edge collecting devices are different, the current acquisition data is converted to obtain the current carbon footprint data with preset units.

S330: deviation statistical analysis is performed on the current carbon footprint data and continue to execute S340. Specifically, deviation statistical analysis is used to analyze whether the dispersion degree of carbon footprint data is within the normal range. For example, if the deviation of current carbon footprint data (indicating dispersion degree) exceeds the deviation of historical carbon footprint data, the current carbon footprint data is judged as abnormal. If the deviation of current carbon footprint data does not exceed the deviation of historical carbon footprint data, the current carbon footprint data is judged as normal.

S340: it is judged whether the analysis result is normal, if so, S350 is executed and S360, if not, S370 is executed. Specifically, the deviation statistical analysis is performed based on the deviation statistical index. The value of the deviation statistical index can be constant or variable. For example, the deviation statistical index can be determined by historical carbon footprint data. After the historical carbon footprint data is updated, the corresponding deviation statistical index is also updated.

S350: the current deviation statistical analysis data is stored in the carbon footprint benchmark database. Specifically, the carbon footprint benchmark database is used to store the deviation statistical index such as deviation statistical analysis data. For example, in the carbon footprint benchmark database, the current deviation statistical analysis data can replace the historical deviation statistical analysis data and be replaced by the subsequent deviation statistical analysis data.

S360: the current carbon footprint data is stored into the carbon footprint query database and continue to execute S380. The carbon footprint data meeting the analysis deviation statistical index is stored in the carbon footprint query database,

S370: trend anomaly analysis is performed. Specifically, the trend anomaly analysis is an analysis other than the deviation statistical index analysis. The trend anomaly analysis can also be the carbon footprint trend of the edge collecting devices other than the edge collecting device. The carbon footprint trend can be the carbon data trend characteristics shared by the carbon footprints of a group of associated edge collecting devices, for example, the product process variation characteristics.

S380: the association between the current carbon footprint data and the identifier of the edge collecting device is updated into a blockchain. Specifically, the data stored in the blockchain is not easy to be tampered with. If the carbon footprint data is updated, the updated carbon footprint data can also be stored in the blockchain. When the carbon footprint data is queried, the nearest carbon footprint data among the carbon footprint data corresponding to the same identifier of the edge collecting device can be determined as the carbon footprint data of the edge collecting device.

The carbon footprint data analysis process in FIG. 4 comprises the following:

S410: the current deviation statistical analysis data is acquired from the carbon footprint benchmark database and continue to execute S420.

S420: deviation statistical analysis is performed on the current carbon footprint data and continue to execute S430. Specifically, the deviation statistical analysis is performed in the carbon footprint benchmark database, that is, the carbon footprint benchmark database performs deviation analysis calculation based on the stored current deviation statistical index and the acquired current carbon footprint data and output the analysis result.

S430: it is judged whether the analysis result is normal. If so, S440 is executed; if not, S450 is executed. Specifically, in one example, in the case of the current deviation statistical index, the normal current carbon footprint data is added to the carbon footprint query database, and the abnormal current carbon footprint data is not added to the carbon footprint query database. In some cases, as the current deviation statistic index is updated, the normal historical carbon footprint data is judged to be abnormal under the current deviation statistic index and must be removed from the carbon footprint query database to a cache database. In one example, the cache database may be a carbon footprint improvement database.

S440: the current carbon footprint data is stored into the carbon footprint database and continue to execute S490. Specifically, the carbon footprint query database is used to store normal carbon footprint data. In one example, the normal current carbon footprint data is added to the carbon footprint query database. In another example, normal historical carbon footprint data is added to the carbon footprint query database. In other words, in the case of the current deviation statistic index, if a carbon footprint data is currently judged to be abnormal, the data will not be added to the carbon footprint query database. As the current deviation statistic index is updated, the historical carbon footprint data meets the current deviation statistic index and is added to the carbon footprint query database.

S450: the trend anomaly analysis starts and continue to execute S460.

S460: the current carbon footprint improvement data is acquired from the carbon footprint improvement database to obtain the trend anomaly analysis result and then execute S470. Specifically, the current peripheral carbon footprint data of a group of edge collecting devices around the edge collecting device can be acquired first, and then the product process variation characteristics of the current peripheral carbon footprint data can be determined.

S470: it is judged whether the trend analysis result is normal. If so, S440 is executed; if not, S480 is executed. Specifically, if both the current carbon footprint data and the current peripheral carbon footprint data are abnormal, it is judged that the effect of the product process variation characteristics is normal, and if the current peripheral carbon footprint data is normal, the product process variation characteristics are judged to be abnormal. Further, in the case of considering the product process variation characteristics, if the product process variation characteristics are not in the range of preferred parameters preset according to industry experience, it is judged that the product process variation characteristics are abnormal. In the case of considering the product process variation characteristics, if the product process variation characteristics are in the range of preferred parameters preset according to industry experience, it is judged that the product process variation characteristics are normal.

S480: a reminder message for the current carbon footprint data is generated. Specifically, the reminder message can be a reminder message from the carbon data management device. For example, the message can be displayed on the display screen of the carbon data management device through a pop-up window, or a reminder sound can be sounded through the speaker of the carbon data management device.

S490: the association between the current carbon footprint data and the identifier of the edge collecting device is updated into a blockchain. Specifically, the data stored in the blockchain is not easy to be tampered with. If the carbon footprint data is updated, the updated carbon footprint data can also be stored in the blockchain. When the carbon footprint data is queried, the nearest carbon footprint data among the carbon footprint data corresponding to the same identifier of the edge collecting device can be determined as the carbon footprint data of the edge collecting device.

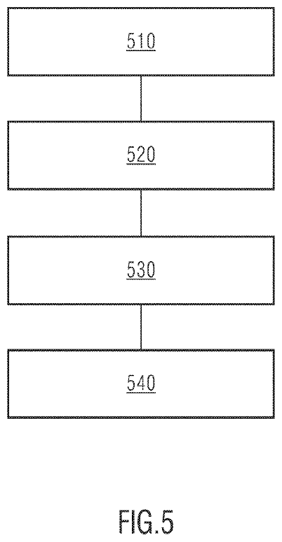

FIG. 5 is a structural schematic diagram of an carbon data management apparatus incorporating teachings of the present disclosure. The carbon data management apparatus includes:
an acquisition module 510, configured to acquire current carbon footprint data of an edge collecting device, wherein the edge collecting device is deployed in a product processing;
a calculation module 520, configured to calculate a current

deviation statistical index based on historical carbon footprint data of the edge collecting device, wherein the historical carbon footprint data is stored in a carbon footprint query database;
a judgment module 530, configured to judge whether the current carbon footprint data is a normal deviation based on the current deviation statistical index;
an update module 540, configured to update the historical carbon footprint data in the carbon footprint query database based on the current carbon footprint data when the current carbon footprint data is a normal deviation.

In some embodiments, the acquisition module is further configured to: acquire product process variation characteristics at the current carbon footprint data collected by the edge collecting device or the input product process variation characteristics when the current carbon footprint data is an abnormal deviation. The judgment module is further configured to: in the case of not considering the product process variation characteristics, update the current carbon footprint data into a carbon footprint improvement database as current carbon footprint improvement data when the current carbon footprint data is a normal deviation.

In some embodiments, the judgment module is further configured to: in the case of considering the product process variation characteristics, judge that the product process variation characteristics are abnormal when the product process variation characteristics are not in a range of preferred parameters preset according to industry experience, and generate a reminder message for the current carbon footprint data.

In some embodiments, the judgment module is further configured to: judge whether historical carbon footprint improvement data in the carbon footprint improvement database is normal based on the current deviation statistical index; and update the historical carbon footprint improvement data into the carbon footprint query database as the historical carbon footprint data when the historical carbon footprint improvement data is normal.

In some embodiments, the judgment module is further configured to: judge that an effect of the product process variation characteristics is normal when the current carbon footprint data is in a carbon footprint data range indicated by the product process variation characteristics, wherein the carbon footprint data range indicated by the product process variation characteristics is input into the carbon footprint improvement database in advance.

In some embodiments, the update module is further configured to: update an association between the current carbon footprint data and an identifier of the edge collecting device into a blockchain.

In some embodiments, the calculation module is configured to: cluster values of the historical carbon footprint data of the edge collecting device to obtain each current cluster; and take a center value of each current cluster and a distance threshold from the corresponding center value as the current deviation statistical index. The judgment module is configured to: judge that the current carbon footprint data is a normal deviation when a distance between a value of the current carbon footprint data and the central value of a cluster is not greater than the distance threshold.

In some embodiments, the judgment module is further configured to: judge that the current carbon footprint data is an abnormal deviation when a distance between the value of the current carbon footprint data and the central value of each cluster is greater than the distance threshold. The acquisition module is further configured to: acquire product process variation characteristics at the current carbon footprint data collected by the edge collecting device or the input product process variation characteristics. The judgment module is further configured to: in the case of not considering the product process variation characteristics, update the current carbon footprint data into a carbon footprint improvement database as current carbon footprint improvement data when the current carbon footprint data is a normal deviation.

In some embodiments, the calculation module is configured to: update a center value of a historical cluster and a distance threshold from the corresponding center value in a carbon footprint benchmark database based on the center value of the current cluster and the distance threshold from the corresponding center value.

The operations and effects of each module in each example of the embodiment of FIG. 5 correspond to respective embodiment of FIG. 2. The description will not be repeated here.

Some examples include a storage medium storing computer executable instructions thereon, wherein the computer executable instructions, when executed, implement one or more of the methods described herein. Further example include a computer program product, comprising a computer readable storage medium on which a program code is stored, wherein the program code, when loaded into a memory of a computer, cause the computer to perform execute one or more of the methods described herein.

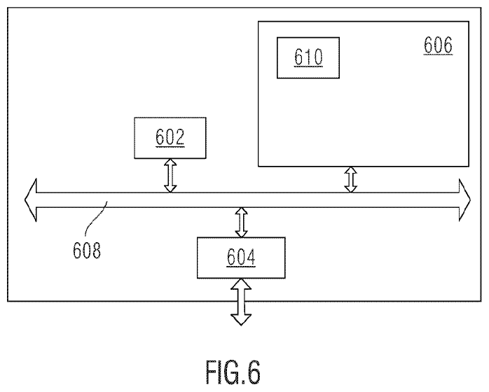

The electronic device of the embodiment of the present disclosure will be described with reference to FIG. 6 hereinafter. In one example, the electronic device may be the carbon data management device of FIG. 1. As shown in FIG. 6, a structural schematic diagram of an example electronic device is shown, and the teachings herein are not limited to the specific implementation of the electronic device. As shown in FIG. 6, the electronic device may comprise a processor 602, a communications interface 604, a memory 606 in which a program (at least one executable instruction) 610 is stored, and a communication bus 608.

The processor, the communication interface and the memory communicate with each other through the communication bus. The communication interface is configured to communicate with other electronic devices or servers. The processor is configured to execute the program, and can specifically execute the relevant method elements. Specifically, the program may include a program code including computer operation instructions.

The processor may be a processor CPU, or an Application Specific Integrated Circuit (ASIC), or one or more integrated circuits configured to implement the embodiments of the present disclosure. One or more processors included in a smart device can be the same type of processors, such as one or more CPUs; or different types of processors, such as one or more CPUs and one or more ASICS.

The memory is configured to store programs. The memory may include a high-speed RAM memory or a non-volatile memory, such as at least one disk memory.

Specifically, the program can be used to cause the processor to perform the corresponding operations of one or more of the methods described herein. In addition, for the specific implementation of each step in the program, refer to the corresponding description the corresponding steps and units in the above method embodiments, which will not be described in detail here. Those skilled in the art can clearly understand that, for the convenience and conciseness of description, the specific working process of the above-described devices and modules can refer to the corresponding process description in the above-mentioned method embodiment, which will not be described in detail here.

According to the needs of implementation, each component/step described in the embodiment of the present disclosure can be split into more components/steps, or two or more components/steps or part of the operations of components/steps can be combined into new components/steps to achieve the purpose of the embodiment of the present disclosure.

The methods of the present disclosure can be implemented in hardware or firmware, or as software or computer code that can be stored in a recording medium (such as CD ROM, RAM, a floppy disk, a hard disk or a magneto-optical disk), or as a computer code that is downloaded through a network and originally stored in a remote recording medium or a non-temporary machine-readable medium and will be stored in a local recording medium, so that the method described herein can be stored in a recording medium using a general-purpose computer, a special-purpose processor or a programmable or special-purpose hardware (such as ASIC or FPGA) for such software processing. It can be understood that a computer, a processor, a microprocessor controller or a programmable hardware comprises a storage component (e.g., RAM, ROM, a flash memory, etc.) that can store or receive a software or a computer code. When accessed and executed by a computer, a processor, or hardware, the software or the computer code implements the method described herein. Furthermore, when the general-purpose computer accesses the code for implementing the method shown here, the execution of the code converts the general-purpose computer into a special-purpose computer for executing the method shown here.

The units and method steps of each example described in connection with the embodiments disclosed herein can be implemented in electronic hardware, or a combination of computer software and electronic hardware. Whether these functions are performed by hardware or software depends on the specific application and design constraints of the technical scheme. Those skilled in the art can use different methods to realize the described functions for each specific application, but this realization should not be considered beyond the scope of the embodiments of the present disclosure.

The above embodiments are only used to illustrate the present disclosure, rather than limit it. Those skilled in the art can make various changes and modifications without departing from the spirit and scope of the present disclosure. Therefore, all equivalent technical schemes also belong to the scope of the present disclosure, and the patent protection scope should be defined by the claims.

What is claimed is:

1. A carbon data management method comprising:
acquiring current carbon footprint data of an edge collecting device, wherein the edge collecting device is deployed in a production process;
calculating a current deviation statistical index based on historical carbon footprint data of the edge collecting device, wherein the historical carbon footprint data is retrieved from a carbon footprint query database;
judging whether the current carbon footprint data is a normal deviation based on the current deviation statistical index; and
updating the historical carbon footprint data in the carbon footprint query database based on the current carbon footprint data when the current carbon footprint data is a normal deviation.

2. The method according to claim 1, further comprising:
acquiring product process variation characteristics at the current carbon footprint data collected by the edge collecting device or the input product process variation characteristics when the current carbon footprint data is an abnormal deviation;
updating the current carbon footprint data into a carbon footprint improvement database as current carbon footprint improvement data when the current carbon footprint data is a normal deviation.

3. The method according to claim 2, further comprising:
judging that the product process variation characteristics are abnormal when the product process variation characteristics are not in a range of preferred parameters preset according to industry experience; and
generating a reminder message for the current carbon footprint data.

4. The method according to claim 2, further comprising:
judging whether historical carbon footprint improvement data in the carbon footprint improvement database is normal based on the current deviation statistical index; and
updating the historical carbon footprint improvement data into the carbon footprint query database as the historical carbon footprint data when the historical carbon footprint improvement data is normal.

5. The method according to claim 2, further comprising:
judging that an effect of the product process variation characteristics is normal when the current carbon footprint data is in a carbon footprint data range indicated by the product process variation characteristics;
wherein the carbon footprint data range indicated by the product process variation characteristics is input into the carbon footprint improvement database in advance.

6. The method according to claim 1, further comprising
updating an association between the current carbon footprint data and an identifier of the edge collecting device into a blockchain.

7. The method according to claim 1, wherein calculating a current deviation statistical index based on historical carbon footprint data of the edge collecting device comprises:
clustering values of the historical carbon footprint data of the edge collecting device to obtain each current cluster; and
taking a center value of each current cluster and a distance threshold from the corresponding center value as the current deviation statistical index;
wherein judging whether the current carbon footprint data is a normal deviation based on the current deviation statistical index comprises:
judging that the current carbon footprint data is a normal deviation when a distance between a value of the current carbon footprint data and the central value of a cluster is not greater than the distance threshold.

8. The method according to claim 7, wherein judging whether the current carbon footprint data is a normal deviation based on the current deviation statistical index further comprises:
judging that the current carbon footprint data is an abnormal deviation when a distance between the value of the current carbon footprint data and the central value of each cluster is greater than the distance threshold;
acquiring product process variation characteristics at the current carbon footprint data collected by the edge collecting device or the input product process variation characteristics;
in the case of not considering the product process variation characteristics, updating the current carbon footprint data into carbon footprint improvement database as current carbon footprint improvement data when the current carbon footprint data is a normal deviation.

9. The method according to claim 7, wherein calculating current deviation statistical index based on historical carbon footprint data of the edge collecting device further comprises:
updating a center value of a historical cluster and a distance threshold from the corresponding center value in a carbon footprint benchmark database based on the center value of the current cluster and the distance threshold from the corresponding center value.

10. A carbon data management apparatus comprising:
an acquisition module to acquire current carbon footprint data of an edge collecting device, wherein the edge collecting device is deployed in a production process;
a calculation module to calculate a current deviation statistical index based on historical carbon footprint data of the edge collecting device, wherein the historical carbon footprint data is stored in a carbon footprint query database;
a judgment module to judge whether the current carbon footprint data is a normal deviation based on the current deviation statistical index; and
an update module to update the historical carbon footprint data in the carbon footprint query database based on the current carbon footprint data when the current carbon footprint data is a normal deviation.

11. The apparatus according to claim 10, wherein:
the acquisition module is further configured to: acquire product process variation characteristics at the current carbon footprint data collected by the edge collecting device or the input product process variation characteristics when the current carbon footprint data is an abnormal deviation; and
the judgment module is further configured to: in the case of not considering the product process variation characteristics, update the current carbon footprint data into a carbon footprint improvement database as current carbon footprint improvement data when the current carbon footprint data is a normal deviation.

12. The apparatus according to claim 11, wherein the judgment module is further configured to:
in the case of considering the product process variation characteristics, judge that the product process variation characteristics are abnormal when the product process variation characteristics are not in a range of preferred parameters preset according to industry experience; and
generate a reminder message for the current carbon footprint data.

13. The apparatus according to claim 11, wherein the judgment module is further configured to:
judge whether historical carbon footprint improvement data in the carbon footprint improvement database is normal based on the current deviation statistical index; and
update the historical carbon footprint improvement data into the carbon footprint query database as the historical carbon footprint data when the historical carbon footprint improvement data is normal.

14. The apparatus according to claim 11, wherein the judgment module is further configured to:
judge that an effect of the product process variation characteristics is normal when the current carbon footprint data is in a carbon footprint data range indicated by the product process variation characteristics;
wherein the carbon footprint data range indicated by the product process variation characteristics is input into the carbon footprint improvement database in advance.

15. The apparatus according to claim 10, wherein the update module is further configured to update an association between the current carbon footprint data and an identifier of the edge collecting device into a blockchain.

16. The apparatus according to claim 10 , wherein
the calculation module is configured to:
cluster values of the historical carbon footprint data of the edge collecting device to obtain each current cluster; and
take a center value of each current cluster and a distance threshold from the corresponding center value as the current deviation statistical index; and
the judgment module is configured to judge that the current carbon footprint data is a normal deviation when a distance between a value of the current carbon footprint data and the central value of a cluster is not greater than the distance threshold.

17. The apparatus according to claim 16, wherein:
the judgment module is further configured to judge that the current carbon footprint data is an abnormal deviation when a distance between the value of the current carbon footprint data and the central value of each cluster is greater than the distance threshold;
the acquisition module is further configured to acquire product process variation characteristics at the current carbon footprint data collected by the edge collecting device or the input product process variation characteristics; and
the judgment module is further configured to in the case of not considering the product process variation characteristics, update the current carbon footprint data into a carbon footprint improvement database as current carbon footprint improvement data when the current carbon footprint data is a normal deviation.

18. The apparatus according to claim 16, wherein the calculation module is configured to update a center value of a historical cluster and a distance threshold from the corresponding center value in a carbon footprint benchmark database based on the center value of the current cluster and the distance threshold from the corresponding center value.

19. An electronic device comprising:
a processor;
a memory;
a communication interface; and
a communication bus;
wherein the processor, the memory, and the communication interface communicate with each other through the communication bus;
the memory stores at least one executable instruction; and the executable instruction enables the processor to:
acquire current carbon footprint data of an edge collecting device, wherein the edge collecting device is deployed in a production process;
calculate a current deviation statistical index based on historical carbon footprint data of the edge collecting device, wherein the historical carbon footprint data is retrieved from a carbon footprint query database;
judge whether the current carbon footprint data is a normal deviation based on the current deviation statistical index; and
update the historical carbon footprint data in the carbon footprint query database based on the current carbon footprint data when the current carbon footprint data is a normal deviation.

20-21. (canceled)
